(19) United States
(12) Patent Application Publication
(10) Pub. No.: US 2022/0283370 A1
(43) Pub. Date: Sep. 8, 2022

(54) A WAVELENGTH CONTROLLABLE ARRAYED WAVEGUIDE GRATING

(71) Applicant: IRIXI PHOTONICS (SUZHOU) CO., LTD., Suzhou (CN)

(72) Inventors: Yifan CHEN, Suzhou (CN); Rui ZHENG, Suzhou (CN)

(21) Appl. No.: 17/632,646

(22) PCT Filed: Nov. 18, 2019
(86) PCT No.: PCT/CN2019/119103

§ 371 Date: Feb. 3, 2022

(30) Foreign Application Priority Data
Aug. 29, 2019 (CN) 201910805952.3

(51) Int. Cl. G02B 6/12

(52) U.S. Cl. CPC G02B 6/12033; G02B 6/12011

(57) ABSTRACT

The present invention discloses a wavelength controllable arrayed waveguide grating, of which the dispersion equation of the arrayed waveguide grating is:

$${n}_{s} ( \frac{{d}_{1} \cdot {x}_{1}}{{f}_{1}} - \frac{d \cdot x}{f} ) + {n}_{c} Δ L = m λ ,$$

where, λ is the work wavelength of the arrayed waveguide grating; ΔL is the geometric length difference between the adjacent arrayed waveguides in the waveguide array; m is the multiple of the central wavelength; n_s is the effective refractive index of the free transmission region; n_c is the effective refractive index of the transmission waveguide; d_1 and d represent the distances between the arrayed waveguides in the first free transmission region and the second free transmission region, respectively; f_1 and f are focal lengths of the first slab waveguide and the second slab waveguide, respectively; x_ 1 and x represent the positions of the input waveguide and the output waveguide on the Rowland circle, respectively.

### CROSS REFERENCE TO RELATED APPLICATIONS

This application claims priority of Chinese Patent Application No. 201910805952.3, filed Aug. 29, 2019, the entire disclosures of both of which are incorporated herein by reference.

### FIELD OF THE INVENTION

The present invention relates to the integrated arrayed waveguide grating device, in particular to a waveguide controllable arrayed waveguide grating.

### DESCRIPTION OF THE PRIOR ART

Integrated AWG (Arrayed Waveguide Grating) is a kind of angular-dispersion passive device, which based on slab optical waveguide technology and was first proposed by Smit in the late 1980s, and then it has attracted the attention of Bell Research Institute, NTT and other research institutions. With the development of slab optical waveguide technology, the corresponding products are gradually commercialized. Compared with other WDM (Wavelength Division Multiplexing) devices, AWG has the advantages of flexible design, low insertion loss, good filtering performance, long-term stability and easy coupling with optical fiber, etc. In addition, AWG is easy to be integrated with optical amplifier, semiconductor laser and other active devices, so as to realize monolithic integration, which is a hot research topic nowadays.

Since the center wavelength of the arrayed waveguide grating is affected by various parameters and processes, there are some differences between the wavelength of actual products and design parameters. In the process of the actual products preparation, it often needs multiple iterations and the optimization of process parameters to stabilize the central wavelength parameters. This process involves many tests, wavelength shift processes and related equipment, resulting in long production cycle and low yield of chips.

The formula of the working wavelength of the arrayed waveguide grating is

$${λ}_{c} = \frac{{n}_{eff} \cdot Δ L}{m}$$

where, n_{eff} is the effective refractive index of the waveguide, ΔL is geometric length difference of the adjacent waveguides, m is the diffraction order, which determines the dispersion ability of the grating.

It is shown from the formula that, the effective refractive index and the geometric length difference of the waveguides affect the central wavelength of devices. For the application of DWDM (Dense Wavelength Division Multiplexing), the control requirements of the central wavelength are very strict. The precision of lithography process, the waveguide width and thickness, and the proportion of the doping components in the core layer during the chip production process will affect the working wavelength of the chip. At present, control methods of wavelength mainly include:

1. Using the design of multi-output waveguide. The arrayed waveguide grating is a dispersion element, and the work wavelength is connected to the position of the output waveguide. For the arrayed waveguide grating with structure, the wavelength is described as:

$$λ = {λ}_{0} + j \cdot \frac{{N}_{c}}{{n}_{c}} \cdot ( \frac{{d}_{1} \cdot {D}_{1} \cdot f}{d \cdot D \cdot {f}_{1}} - 1 ) {Δλ}_{out}$$

where, j is the position number of the waveguide array, the formula shows that at different positions. The fluctuations possibly occur during the design and process can be compensated by introducing a certain amount of wavelength deviation to the central wavelength. This method is relatively complex and difficult to be fine controlled.

2. Using stress annealing to control the wavelength. Since the materials are different in the substrate and the core layer, there will be some stress in the growth process of the chip. In the high temperature environment, the state of the core layer material shows fluidity, which will redistribute the stress of the chip, so as to change the refractive index of the waveguide structure and offset the wavelength of the chip. This method needs to be tested for many times to obtain the relationship curve between the wavelength shift and the annealing time, which is kind of tedious.

Therefore, it is necessary to provide a wavelength controllable arrayed waveguide grating with simple structure and easy to realize fine wavelength control to solve the above problems.

BRIEF SUMMARY OF THE INVENTION

In order to solve the technical problems mentioned above, the present invention aims to provide a wavelength controllable arrayed waveguide grating, so as to eliminate the influence of process parameter fluctuation on the working wavelength, and realize the accurate control of the working wavelength.

To achieve the foregoing objective, the present invention is realized as a wavelength controllable arrayed waveguide grating, which includes a planar substrate; and the following structure disposed on the planar substrate:

at least one input waveguide for inputting optical signal;

a first free transmission region, composed of a first slab waveguide and coupled with the output end of the input waveguide;

a waveguide array, coupled with the output end of the first free transmission region;

a second free transmission region, composed of a second slab waveguide and coupled with the output end of the waveguide array;

at least one output waveguide for outputting optical signal, coupled with the output end of the second free transmission region;

the dispersion equation of the arrayed waveguide grating is shown as follows:

$${n}_{s} ( \frac{{d}_{1} \cdot {x}_{1}}{{f}_{1}} - \frac{d \cdot x}{f} ) + {n}_{c} Δ L = m λ$$

where, λ is the work wavelength of the arrayed waveguide grating; ΔL is the geometric length difference between the adjacent arrayed waveguides in the waveguide array; m is the multiple of the central wavelength; nₛ is the effective refractive index of the free transmission region; n_{c} is the effective refractive index of the transmission waveguide; d₁ and d represent the distances between the arrayed waveguides in the first free transmission region and the second free transmission region, respectively; f₁ and f are focal lengths of the first slab waveguide and the second slab waveguide, respectively; x₁ and x represent the positions of the input waveguide and the output waveguide on the Rowland circle, respectively.

Further, the arrayed waveguide grating is divided into a smaller first part and a larger second part by at least one divisional plane, and the divisional plane transversely passes through at least one of the first free transmission region and the second free transmission region.

Further, the angle between the divisional plane and the upper surface of the planar substrate is a right angle, an acute or an obtuse angle.

Further, the first part and the second part are connected by a fixed piece. For example, assembling the first and the second part on a fixed substrate, respectively, and synthesizing the two parts into a complete overall structure.

Further, the first part and the second part are connected by an adhesive to be assembled into a complete overall structure.

During the process of assembly, the relative position of the first part and the second part is adjusted through coupling monitoring. For example, the first part moves relative to the second part along the direction of divisional line, and the position of the input waveguide or output waveguide on the Rowland circle (i.e. x₁ and x) changes at this time, so as to compensate for the working wavelength (i.e. λ) of the arrayed waveguide grating.

Further, the region of the divisional plane is filled with a refractive index matching curing agent.

Further, the first part can be replaced by an optical fiber waveguide.

Further, the waveguide array consists of a series of arrayed waveguides with geometric length increasing in arithmetic progression.

The beneficial effect of the present invention is: the technical scheme of the present invention overcomes a problem of wavelength shift caused by the process parameters in the manufacturing process of arrayed waveguide grating chips, and proposes a design structure of arrayed waveguide grating, which compensates for the central wavelength shift caused by the deviation of process and design through adjusting the position of the input waveguide and output waveguide. The arrayed waveguide grating in the resent invention has a simple structure and is easy to implement, which can also accurately regulate the wavelength.

The above description is only an outline of the technical schemes of the present invention. Preferred embodiments of the present invention are provided below in conjunction with the attached drawings to enable one with ordinary skill in the art to better understand said and other objectives, features, and advantages of the present invention and to make the present invention accordingly.

### BRIEF DESCRIPTION OF THE DRAWINGS

FIG. 1 is a structural diagram depicting the wavelength controllable arrayed waveguide grating in embodiment 1 of the present invention, where, 101—input waveguide, 102—output waveguide, 103—first free transmission, 104—second free transmission, 105—waveguide array, 110—first part, 120—second part, 130—divisional plane, 140—planar substrate.

FIG. 2 is a structural diagram depicting the wavelength controllable arrayed waveguide grating in embodiment 2 of the present invention, where, 202—output waveguide, 203—first free transmission region, 204—second free transmission, 205—waveguide array, 210—optical fiber waveguide, 220—second part, 230—divisional plane, 240—planar substrate, 250—fixed substrate.

### DETAILED DESCRIPTION OF THE PREFERRED EMBODIMENTS

Specific embodiments of the present invention are described in further detail in combination with the related drawings and embodiments below. However, in addition to the descriptions given below, the present invention can be applied to other embodiments, and the scope of the present invention is not limited by such, rather by the scope of the claims.

### Embodiment 1

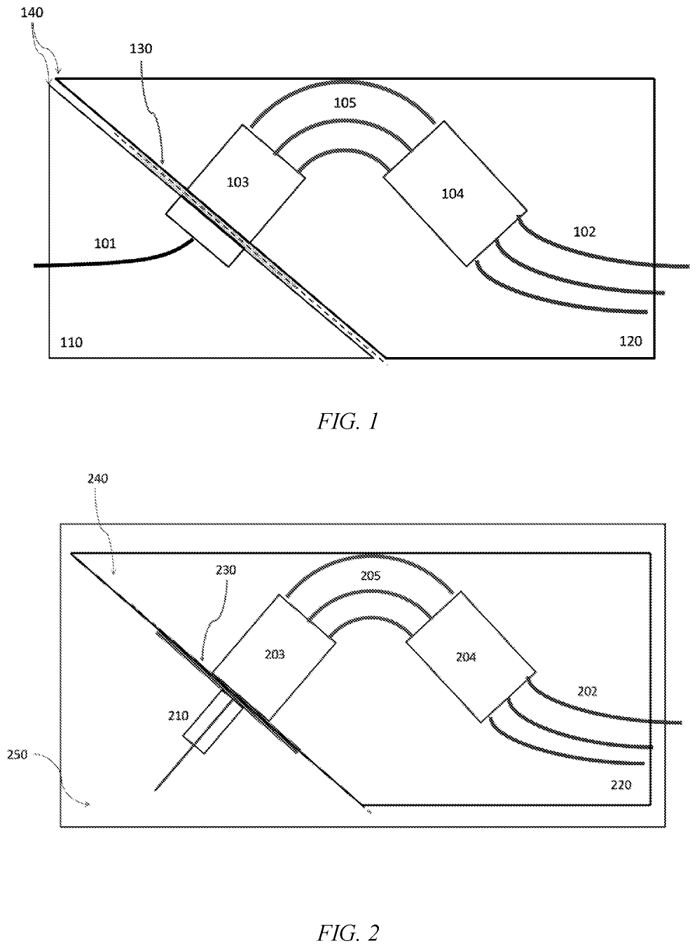

Referring to FIG. 1, which shows a wavelength controllable arrayed waveguide grating, including a planar substrate (140), and the following structure disposed on the planar substrate (140):

an input waveguide (101) for inputting optical signal;

a first free transmission region (103), composed of a first slab waveguide and coupled with the output end of the input waveguide (101);

a waveguide array (105), coupled with the output end of the first free transmission region (103);

a second free transmission region (104), composed of a second slab waveguide and coupled with the output end of the waveguide array (105);

at least one output waveguide (102) for outputting optical signal, coupled with the output end of the second free transmission region (104);

and the dispersion equation of the arrayed waveguide grating is shown as follows:

$${n}_{s} ( \frac{{d}_{1} \cdot {x}_{1}}{{f}_{1}} - \frac{d \cdot x}{f} ) + {n}_{c} Δ L = m λ$$

where, λ is the work wavelength of the arrayed waveguide grating; ΔL is the geometric length difference between the adjacent arrayed waveguides in the waveguide array; m is the multiple of the central wavelength; nₛ is the effective refractive index of the free transmission region; n_{c} is the effective refractive index of the transmission waveguide; d₁ and d represent the distances between the arrayed waveguides in the first free transmission region (103) and the second free transmission region (104), respectively; f₁ and f are focal lengths of the first slab waveguide and the second slab waveguide, respectively; x₁ and x represent the position of the input waveguide (101) and the output waveguide (102) on the Rowland circle, respectively. According to the application requirements, the geometric structure: d₁, d, f₁, f, ΔL, and effective refractive index: n_{c}, nₛ can be determined.

In this embodiment, the arrayed waveguide grating is divided into a smaller first part (110) and a larger second part (120) by a divisional plane (130). The divisional plane (130) transversely passes through the first free transmission region (103), and is perpendicular to the upper surface of the planar substrate (140), or inclined to the upper surface of the planar substrate (140) with an angle (i.e., perpendicular to the central axis of the first free transmission region (103) or inclined with an angle to the central axis of the first free transmission zone (103)).

In this embodiment, the first part (110) and the second part (120) are connected by an adhesive. During the process of assembly, the working central wavelength of the arrayed waveguide grating λ is determined first; and then, according to the application requirements, the geometric structures: d₁, d, f₁, f, ΔL and effective refractive index of the waveguide: n_{c}, nₛ are determined; next, adjust the relative position of the first part (110) and the second part (120) through the coupling monitoring, for example, the first part (110) moves relative to the second part (120) along the direction of divisional line, and the position of the input waveguide (101) or output waveguide (102) on the Rowland circle (i.e. x₁ and x) changes at this time, so as to compensate for the working wavelength (i.e. λ) of the arrayed waveguide grating according to the dispersion equation of the arrayed waveguide grating; after adjusting the position, an adhesive is used to fix the two parts into a complete overall structure, and to ensure that there is no relative displacement between the two parts.

In this embodiment, the region of the divisional plane (130) is filled with a refractive index matching curing agent.

In this embodiment, the waveguide array (105) consists of a series of arrayed waveguides with geometric length increasing in arithmetic progression.

### Embodiment 2

Referring to FIG. 2, which shows a wavelength controllable arrayed waveguide grating device, including a planar substrate (240), and the following structure disposed on the planar substrate (240):

an input waveguide (not marked in FIG. 2) for inputting optical signal;

a first free transmission region (203), composed of a first slab waveguide and coupled with the output end of the input waveguide;

a waveguide array (205), coupled with the output end of the first free transmission region (203);

a second free transmission region (204), composed of a second slab waveguide and coupled with the output end of the waveguide array (205);

at least one output waveguide (202) for outputting optical signal, coupled with the output end of the second free transmission region (204);

and the dispersion equation of the arrayed waveguide grating is shown as follows:

$${n}_{s} ( \frac{{d}_{1} \cdot {x}_{1}}{{f}_{1}} - \frac{d \cdot x}{f} ) + {n}_{c} Δ L = m λ$$

where, λ is the work wavelength of the arrayed waveguide grating; ΔL is the geometric length difference between the adjacent arrayed waveguides in the waveguide array; m is the multiple of the central wavelength; nₛ is the effective refractive index of the free transmission region; n_{c}, is the effective refractive index of the transmission waveguide; d₁ and d represent the distances between the arrayed waveguides in the first free transmission region (203) and the second free transmission region (204), respectively; f₁ and f are focal lengths of the first slab waveguide and the second slab waveguide, respectively; x₁ and x represent the position of the input waveguide (201) and the output waveguide (202) on the Rowland circle, respectively. According to the application requirements, the geometric structure: d₁, d, f₁, f, ΔL, and effective refractive index: n_{c}, nₛ can be determined.

In this embodiment, the arrayed waveguide grating is divided into a smaller first part (not marked in FIG. 2) and a larger second part (220) by a divisional plane (230). The divisional plane (230) transversely passes through the first free transmission region (203), and is perpendicular to the upper surface of the planar substrate (240), or inclined to the upper surface of the planar substrate (240) with an angle (i.e., perpendicular to the central axis of the first free transmission region (203) or inclined with an angle to the central axis of the first free transmission zone (203)).

In this embodiment, the first part (i.e., the input waveguide which has been divided) is replaced by an external optical fiber waveguide (210).

In this embodiment, the optical fiber waveguide (210) and the second part (120) are connected through a fixed piece, such as fixed substrate (250). During the process of assembly, the working central wavelength of the arrayed waveguide grating A. is determined first; and then, according to the application requirements, the geometric structures: d₁, d, f₁, f, ΔL and effective refractive index of the waveguide: nₛ are determined; next, adjust the relative position of the optical fiber waveguide (210) and the second part (220) through the coupling monitoring, for example, the optical fiber waveguide (210) moves relative to the second part (220) along the direction of divisional line, and the position of the optical fiber waveguide (210) or output waveguide (202) on the Rowland circle (i.e. x₁ and x) changes at this time, so as to compensate for the working wavelength (i.e. λ) of the arrayed waveguide grating according to the dispersion equation of the arrayed waveguide grating; after adjusting the position, assembling the optical fiber waveguide (210) and the second part (220) on the fixed substrate (250), respectively, so as to fix the two parts into a complete overall structure, and to ensure that there is no relative displacement between the two parts.

In this embodiment, the region of the divisional plane (230) is filled with a refractive index matching curing agent.

In this embodiment, the waveguide array (205) consists of a series of arrayed waveguides with geometric length increasing in arithmetic progression.

Moreover, in other embodiments, the divisional plane can also transversely pass through the second free transmission region, and is perpendicular to the upper surface of the planar substrate, or inclined to the upper surface of the planar substrate with an angle, and the smaller first part is part of the output waveguide which has been divided. The same technical effect can be achieved by adjusting the relative position of the first part and the second part (i.e., x₁ and x) according to the dispersion equation of the arrayed waveguide grating, so as to compensate for the working wavelength (i.e. λ) of the arrayed waveguide grating, and finally, fixing the two parts by adhesive or fixed piece. At the same time, the smaller first part can still be replaced by external units to enhance its technical effect, such as an optical fiber waveguide.

The technical scheme of the present invention overcomes a problem of wavelength shift caused by the process parameters in the manufacturing process of arrayed waveguide grating chips, and proposes a design structure of arrayed waveguide grating, which compensates for the central wavelength shift caused by the deviation of process and design through adjusting the position of the input waveguide and output waveguide. The arrayed waveguide grating in the resent invention has a simple structure and is easy to implement, which can also accurately regulate the wavelength.

The technical features of the above embodiments can be combined arbitrarily, in order to make the description concise, not all possible combinations of the technical features in the above embodiments are described. However, as long as there is no contradiction between the combination of these technical features, they shall be considered to be within the scope of this specification.

The present invention only described several above embodiments, which are described more specific and detailed, but it cannot be understood as a limitation on the scope of the present invention. It should be pointed out that for ordinary technical personnel in the art, without departing from the concept of the present invention, a number of deformation and improvements can be made, which belong to the scope of the present invention. Therefore, the scope of the present invention shall be subject to the recorded claims.

1. A wavelength controllable arrayed waveguide grating, characterized in that including a planar substrate; and the following structure disposed on the planar substrate:
at least one input waveguide for inputting optical signal;
a first free transmission region, composed of a first slab waveguide and coupled with the output end of the input waveguide;
a waveguide array, coupled with the output end of the first free transmission region;
a second free transmission region, composed of a second slab waveguide and coupled with the output end of the waveguide array;
at least one output waveguide for outputting optical signal, coupled with the output end of the second free transmission region;
the dispersion equation of the arrayed waveguide grating is shown as follows:
$${n}_{s} ( \frac{{d}_{1} \cdot {x}_{1}}{{f}_{1}} - \frac{d \cdot x}{f} ) + {n}_{c} Δ L = m λ$$
where, λ is the work wavelength of the arrayed waveguide grating; ΔL is the geometric length difference between the adjacent arrayed waveguides in the waveguide array; m is the multiple of the central wavelength; nₛ is the effective refractive index of the free transmission region; n_{c} is the effective refractive index of the transmission waveguide; d₁ and d represent the distances between the arrayed waveguides in the first free transmission region and the second free transmission region, respectively; f₁ and f are focal lengths of the first slab waveguide and the second slab waveguide, respectively; x₁ and x represent the positions of the input waveguide and the output waveguide on the Rowland circle, respectively.

2. The wavelength controllable arrayed waveguide grating to claim 1, characterized in that the arrayed waveguide grating is divided into a smaller first part and a larger second part by at least one divisional plane, and the divisional plane transversely passes through at least one of the first free transmission region and the second free transmission region.

3. The wavelength controllable arrayed waveguide grating to claim 2, characterized in that the angle between the divisional plane and the upper surface of the planar substrate is a right angle, an acute or an obtuse angle.

4. The wavelength controllable arrayed waveguide grating to claim 2, characterized in that the first part and the second part are connected by a fixed piece.

5. The wavelength controllable arrayed waveguide grating to claim 4, characterized in that the fixed piece is a fixed substrate.

6. The wavelength controllable arrayed waveguide grating to claim 2, characterized in that the first part and the second part are connected by an adhesive.

7. The wavelength controllable arrayed waveguide grating to claim 2, characterized in that the region of the divisional plane is filled with a refractive index matching curing agent.

8. The wavelength controllable arrayed waveguide grating to claim 2, characterized in that the first part can be replaced by an optical fiber waveguide.

9. The wavelength controllable arrayed waveguide grating to claim 1, characterized in that the waveguide array consists of a series of arrayed waveguides with geometric length increasing in arithmetic progression.
